(19) United States
(12) Patent Application Publication
(10) Pub. No.: US 2020/0158906 A1
(43) Pub. Date: May 21, 2020

(54) Metal Detector

(71) Applicant: Minelab Electronics Pty. Limited, Mawson Lakes (AU)

(72) Inventors: Philip Shane Wahrlich, Mawson Lakes (AU); Ruifeng Huang, Mawson Lakes (AU)

(21) Appl. No.: 16/690,489

(22) Filed: Nov. 21, 2019

(30) Foreign Application Priority Data
Nov. 21, 2018 (AU) 2018904438

(51) Int. Cl. G01V 3/165; G01V 3/38

(52) U.S. Cl. CPC G01V 3/165; G01V 3/38

(57) ABSTRACT

A method for detecting a target using a metal detector, including: transmitting a transmit magnetic field using a transmitter based on a multiple-frequency transmit signal; receiving a receive magnetic field due to the transmit magnetic field using a receiver to produce a receive signal; processing the receive signal using at least two sets of demodulation functions; each set including at least two demodulation functions that substantially complement each other such that when at a particular time one has a low sensitivity to a particular noise signal, the other has an effective sensitivity to detect that particular noise signal; each of at least two of the at least two demodulation functions is sensitive to at least two frequencies; and each of at least two of the at least two sets of demodulation functions is sensitive to different frequencies of the transmit signal; selecting a set of demodulation functions from the at least two sets of demodulation functions which produces the lowest noise in the step of processing the receive signal; and processing a subsequent receive signal using a linear combination of the at least two demodulation functions of the selected set of demodulation functions to produce an output signal indicative of the target within an influence of the transmit magnetic field.

### CROSS-REFERENCE TO RELATED APPLICATION

This application claims priority to Australian Patent Application No. 2018904438 filed Nov. 21, 2018, the disclosure of which is hereby incorporated by reference in its entirety.

### TECHNICAL FIELD

The present disclosure relates to a metal detector.

### BACKGROUND

The general forms of most metal detectors which interrogate soil are either handheld battery operated units, conveyor-mounted units, or vehicle-mounted units. Examples of handheld products include detectors used to locate gold, explosive land mines or ordnance, coins and treasure. Examples of conveyor-mounted units include fine gold detectors in ore mining operations, and examples of a vehicle-mounted unit include a unit to locate buried land mines.

These metal detectors usually, but not necessarily, consist of transmit electronics generating a repeating transmit signal cycle of a fundamental period, which is applied to an inductor, for example a transmit coil, which transmits a resulting varying magnetic field, sometimes referred to as a transmit magnetic field.

These metal detectors may also contain receive electronics that processes a receive signal from a measured receive magnetic field, during one or more receive periods during the repeating transmit signal cycle, to produce an indicator output signal, the indicator output signal at least indicating the presence of at least a metal target within the influence of the transmit magnetic field.

During the processing of the receive signal, the receive signal is either sampled, or demodulated, to produce one or more target channels, the one or more target channels may be further processed to produce the indicator output signal.

### SUMMARY

According to a first aspect of the present disclosure, there is provided a method for detecting a target using a metal detector, including: transmitting a transmit magnetic field using a transmitter based on a multiple-frequency transmit signal; receiving a receive magnetic field due to the transmit magnetic field using a receiver to produce a receive signal; processing the receive signal using at least two sets of demodulation functions; each set including at least two demodulation functions that substantially complement each other such that when at a particular time one has a low sensitivity to a particular noise signal, the other has an effective sensitivity to detect that particular noise signal; each of the at least two demodulation functions is sensitive to at least two frequencies; and each of the at least two sets of demodulation functions is sensitive to different frequencies of the transmit signal; selecting a set of demodulation functions from the at least two sets of demodulation functions which produces the lowest noise in the step of processing the receive signal; and processing a subsequent receive signal using a linear combination of the at least two demodulation functions of the selected set of demodulation functions to produce an output signal indicative of the target within an influence of the transmit magnetic field.

In one form, the metal detector is a time-domain detector, and the at least two sets of demodulation functions are sets of time-domain demodulation functions. In one form, the transmit magnetic field is turned off temporarily during the step of processing the receive signal using at least two sets of demodulation functions. In one form, the at least two demodulation functions that substantially complement each other are substantially related by a Hilbert transform. In one form, the at least two demodulation functions that substantially complement each other substantially have either π/2 radians or −π/2 radians phase difference for all relevant frequencies in the frequency domain.

In one form, a signal of multiple frequencies is fed to the transmitter to generate the transmit magnetic field. In one form, the step of processing the receive signal using at least two sets of demodulation functions is performed when the detector is powered up or when a user of the metal detector instructs the metal detector to do so. In one form, there are at least ten sets of demodulation functions; and wherein the step of processing the receive signal using at least two sets of demodulation functions for selecting the set of demodulation functions which produces the lowest noise is completed within 1 second. In one form, at least one of the at least two demodulation functions is configured and adapted to detect the target. In one form, a combination of at least two of the at least two demodulation functions is configured and adapted to detect the target.

According to a second aspect of the present disclosure, there is provided a method for detecting a target using a metal detector, including: transmitting a transmit magnetic field using a transmitter based on a multiple-frequency transmit signal; receiving a receive magnetic field due to the transmit magnetic field using a receiver to produce a receive signal; processing the receive signal using at least two sets of demodulation functions; each of at least two of the at least two sets of demodulation functions is sensitive to different frequencies of the transmit signal; each set including at least two demodulation functions, the at least two demodulation functions are in a space spanned by at least two complementary demodulation functions, wherein the at least two complementary demodulation functions substantially complement each other such that when at a particular time one has a low sensitivity to a particular noise signal, the other has an effective sensitivity to detect that particular noise signal; each of at least two of the at least two complementary demodulation functions is sensitive to at least two frequencies; selecting a set of demodulation functions from the at least two sets of demodulation functions which produces the lowest noise in the step of processing the receive signal; and processing a subsequent receive signal using a linear combination of the at least two demodulation functions of the selected set of demodulation functions to produce an output signal indicative of the target within an influence of the transmit magnetic field.

According to another aspect of the present disclosure, there is provided a non-transitory computer readable medium including instructions to perform the steps of the first aspect or the second aspect.

According to another aspect of the present disclosure, there is provided a metal detector including: a transmitter for transmitting a transmit magnetic field based on a multiple-frequency transmit signal; a receiver for receiving a receive magnetic field due to the transmit magnetic field to produce a receive signal; a processor for: processing the receive signal using at least two sets of demodulation functions; each set including at least two demodulation functions that substantially complement each other such that when at a particular time one has a low sensitivity to a particular noise signal, the other has an effective sensitivity to detect that particular noise signal; each of the at least two demodulation functions is sensitive to at least two frequencies; and each of the at least two sets of demodulation functions is sensitive to different frequencies of the transmit signal; selecting a set of demodulation functions from the at least two sets of demodulation functions which produces the lowest noise in the step of processing the receive signal; and processing a subsequent receive signal using a linear combination of the at least two demodulation functions of the selected set of demodulation functions to produce an output signal indicative of the target within an influence of the transmit magnetic field.

### BRIEF DESCRIPTION OF DRAWINGS

Embodiments of the present disclosure will be discussed with reference to the accompanying drawings wherein:

FIG. 1 depicts a transmit voltage signal to be sent to a transmitter for generating a transmit magnetic field;

FIG. 2 depicts a decay curve for a soil exhibiting VRM, and the decay curve (during the zero voltage period) for a first-order conductive target of interest with a time constant of 31.25 μs;

FIG. 3 shows an exemplary function which is insensitive to the viscous remanent magnetism decay curve shown in FIG. 2;

FIG. 4 shows steps involved in a general form of one embodiment;

FIG. 5 shows the discrete Hilbert transform of the function of FIG. 3;

FIG. 6 shows a demodulation function discretised to nine gain levels. This demodulation function approximates the demodulation function shown in FIG. 5; and

FIG. 7 shows an example of steps which enable an automatic selection of an approximately optimal operating mode for a two-channel pulse induction metal detector.

### DESCRIPTION OF EMBODIMENTS

During an operation of a metal detector to detect intended targets such as gold, explosive land mines or ordnance, coins or treasure, it is often required to calibrate the metal detector in the field of detection or environment just before the operation to detect the target. This is so that the metal detector takes into consideration the environment so that any noise or signal due to the environment, not due to the intended targets, be minimised or eliminated from an output signal to a user of the metal detector. As a result, the output signal has improved precision in identifying intended targets, since the number of false positives due to noise or signal due to the environment can be minimised. The output signals can be presented to a user through a screen or through a headphone as sound.

For example the detection environment can be an inner city park, a place near a power transmission line, a crop field near a small town etc. A calibration in the context of this specification refers to selecting one or more functions used to process received signals to generate a processed signal. Sometimes a function is also known as a demodulation function. In one form, a function is a synchronous demodulation function.

In one form, multiple functions are used to process received signals where at least one function is designed such that an intermediate signal which is sensitive to signals due to ground is produced, at least one function is designed such that an intermediate signal which is sensitive to one or more types of target (coins, gold etc) is produced. However, it was discovered that there is no one function that could be the best function to be used in every detection environment. The noise, sometimes also known as interfering signals, in every environment is different most of the time, and different functions have different sensitivities to these interfering signals. An interfering signal may be electromagnetic interference (EMI).

Electromagnetic interference (EMI) can be present in any part of the spectrum. For a metal detector, problematic sources of interference include the domestic power grid. The operating frequency of the domestic power grid (50 Hz or 60 Hz depending on country) is generally not a problem for metal detectors since they operate at higher frequencies (in the kHz range), however harmonics of the operating frequency exist in the operating frequency range of metal detectors and pose a substantial problem. Other sources of EMI include terrestrial VLF transmitters, lightning, and mobile phones.

After the detection of interfering signals, steps may be taken to reduce or eliminate the detected interfering signals such that the interfering signals would not affect the production of an output signal indicating a presence of a target when a target is indeed within the influence of the transmit field of a metal detector in operation.

One way is to have different selectable sets of functions used to process a receive signal. Some functions are more sensitive to certain interfering signals, some more sensitive to the other interfering signals. During the calibration process at a detection environment, one can manually search through the different sets of functions to decide which sets of functions can best reduce or eliminate the interfering signals at that detection environment. Alternatively, one can program the metal detector so that the metal detector will automatically search through different sets of functions while monitoring the noise level, then select the set of functions which generates the least amount of noise. Of course, compared to manual selection, automatic selection is preferable as it saves time, and can be more accurate in comparing noise levels due to different sets of functions. However, the time required to evaluate many different functions imposes a burden on the metal detector operator.

To illustrate this issue further, an exemplary scenario is presented below. This example in the scenario is by no means limiting.

In this scenario, a function includes a demodulation function which is substantially insensitive to the decay curve due to a soil exhibiting viscous remanent magnetism (VRM) generated by the transmitter. This demodulation function has a zero integral, so is also substantially insensitive to very low frequency signals produced by the receive coil moving though static magnetic fields (such as the magnetic field of the Earth) in such a way that the flux through the coil changes with time. The demodulation function is also sensitive to the decay curve due to the wide range of conductive targets of interest. By design, the demodulation function shown in FIG. 3 is sensitive to an exponential decay curve with a time constant of 31.25 μs in particular, corresponding to that of a first-order conductive target with a relaxation frequency of 5.093 kHz.

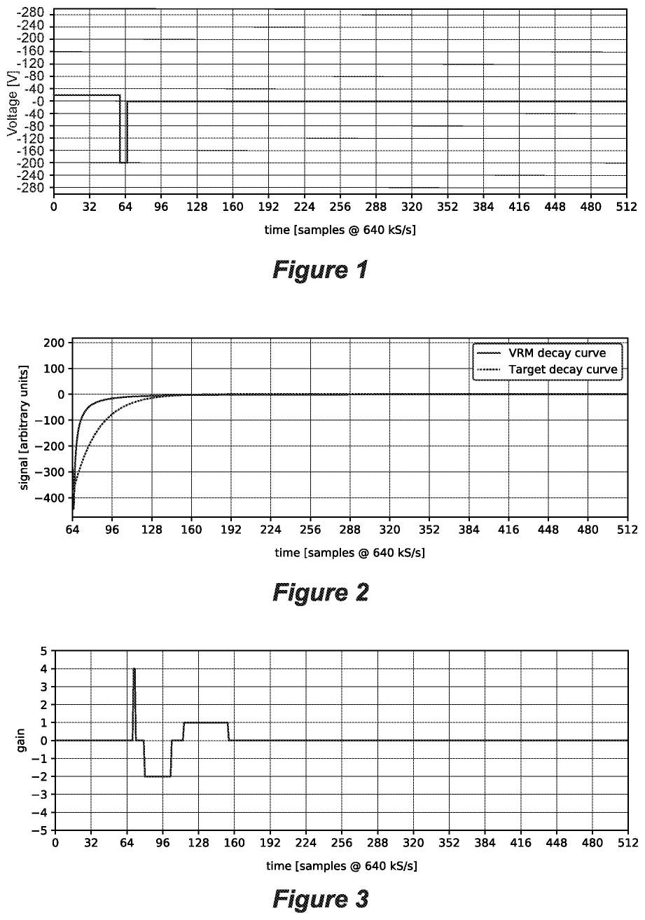

For example, FIG. 1 depicts a transmit voltage signal to be sent to a transmitter for generating a transmit magnetic field. In this example, the transmit voltage signal includes a low voltage period of 20 V followed by a high voltage period of −200 V. The high voltage period is then followed by a zero voltage period. The transmit voltage signal is characterised in that the corresponding transmit magnetic field can generate eddy currents within the intended targets, so a field due to the eddy current can be detected by the metal detector, providing an indication of the presence of a target. Of course this is just a mere example, and there are many ways to generate an excitation signal, such as signals used by a Pulse Induction (PI) metal detector, or a continuous-wave (CW) detector.

FIG. 2 depicts a decay curve for a soil exhibiting VRM, and the decay curve (during the zero voltage period of FIG. 1) for a first-order conductive target of interest with a time constant of 31.25 μs. It is useful to detect the signals represented by the target decay curve but the signals represented by the VRM decay curve are noises that would affect the sensitivity of the metal detector to detect the signals due to the target.

FIG. 3 shows an exemplary function which is insensitive to the viscous remanent magnetism decay curve shown in FIG. 2. In other words, using this function to process a receive signal, which includes the signal represented by the VRM decay curve and the signal represented by the target decay curve of FIG. 2, will produce a signal which includes signals from the targets but with minimal contribution from the VRM of the soil. Accordingly, the sensitivity of the metal detector to the target is increased.

Functions or demodulation functions expressed as a discrete function of time are suitable for implementation on a digital platform, where the mixing operation of the demodulator is implemented in digital signal processing on a sampled received signal. However, the demodulation function may also be expressed as a continuous function of time, suitable for implementation on an analogue platform, where the mixing operation of the demodulator is implemented in analogue signal processing.

The integral of the product of the demodulation function with the decay curve for soil exhibiting viscous remanent magnetism is close to zero compared to the sum of the decay curve itself, indicating that the demodulation function is substantially insensitive to the decay curve due to the soil. The sum of the product of the demodulation function with the decay curve for the first-order target of the interest with time constant of 31.25 μs is not close to zero, indicating that the demodulation function is sensitive to the decay curve from the target.

The demodulation function has a fundamental frequency of 1.25 kHz, and has a rich spectrum of both even and odd harmonics. The demodulator will therefore translate frequency content centred on the fundamental and associate harmonics down to baseband. In a metal detector, a low-pass filter or band-pass filter is typically applied to the demodulated channel which significantly attenuates the baseband content above some frequency, say, 40 Hz. Some frequency content remains not significantly attenuated by this filter. Generally, frequency content in the 0-20 Hz band may be somewhat preserved without significant attenuation.

Some metal detectors are capable of altering their operating frequency. This can be accomplished by modifying the transmitted waveform and correspondingly modifying the demodulation functions. For example, the transmit waveform and demodulation functions may be stretched or compressed in time to shift the operating frequency lower or higher respectively. Alternatively, the transmit waveform and demodulation function may be altered in a more significant way so that the metal detector is sensitive to a different set of frequencies.

The user of the metal detector may be able to choose between a set of different operating modes which effect these sorts of changes to the metal detector. The user may make this selection by trial and error, changing which operating mode is in effect until they are satisfied with the level of EMI present.

In some detectors, the function of selecting the best operating mode is automated. Typically, this requires automatically exploring the set of available operating modes, determining the level of EMI present in each, comparing the determined levels of EMI present in each, and automatically selecting the operating mode with the lowest level of EMI present. With a small set of available operating modes, it may be the case that none of the operating modes has an acceptably low level of EMI present. By increasing the size of the set of available operating modes it is more likely that one of the available operating modes has an acceptably low level of EMI present. However, this presents a problem in that the time required to measure the level of EMI for each operating mode can be long, especially when accounting for the possibility of very low-frequency oscillations caused by EMI. For example, to explore 10 different operating modes, each measuring the amplitude of potential EMI oscillations over 4 seconds (so that a complete oscillation of a 0.25 Hz sinusoid may be observed) would take a total of 40 seconds, not including any dead time which is elapsed in having to wait for transient signals, associated with changing operating modes, to dissipate. The long duration of this process is undesirable, since the user must spend time waiting for the process to reach completion. Additionally, if the process could be completed in a short period of time then it could be scheduled to complete during times when the user would not be adversely impacted by a wait time. For instance, a short automatic operating mode selection could be performed while the metal detector is executing a power-on sequence. Another advantage of a short process is that it becomes feasible to, without adversely impacting the user with a long wait time, configure many metal detectors in close proximity such that they do not interfere with each other. This situation frequently arises at metal detector clubs, organised events, as well as in goldfields where many users are searching a small area of ground.

With a single-frequency continuous wave (CW) metal detector, typically complex-demodulation is applied to the receive signal, yielding an in-phase and quadrature channel. These channels are an orthogonal pair. This means that sinusoidal baseband signals will appear in both channels offset in phase π/2 radians. This can alleviate the need to dwell for a long period of time in order to measure the amplitude of an EMI oscillation, since the amplitude can be measured instantaneously from the magnitude of the orthogonal channel pair.

For a multi-frequency continuous wave metal detector or a pulse induction metal detector, the receive signal is often demodulated using a demodulation function that is sensitive to at least two frequencies. The present disclosure provides a means of reducing the dwell time required in order to measure the amplitude of an EMI oscillation for both multi-frequency continuous wave metal detectors and pulse induction metal detectors.

Consider a sinusoidal EMI signal at 1.251 kHz. This signal is 1 Hz above the fundamental frequency of the demodulation function shown in FIG. 3, and will be shifted to 1 Hz at the output of the demodulator. In order to observe a complete oscillation of the EMI signal at the output of the demodulator, the signal must be observed for 1 second. To detect the presence of an EMI signal, one need not observe for such a long period of time, however the observation time must be long enough so as not to observe the sinusoidal 1 Hz signal during a period where the oscillation is sufficiently close to zero that it is not easily detectable above other sources of noise (e.g. electronic noise from the preamplifier). If one wishes to determine the amplitude of the oscillation with reasonable accuracy, a longer observation is desirable.

The present disclosure offers an alternative to reduce the time for observation or calibration to select the most suitable sets of functions to be used in a detection environment before a metal detector is used to detect an intended target in that detection environment.

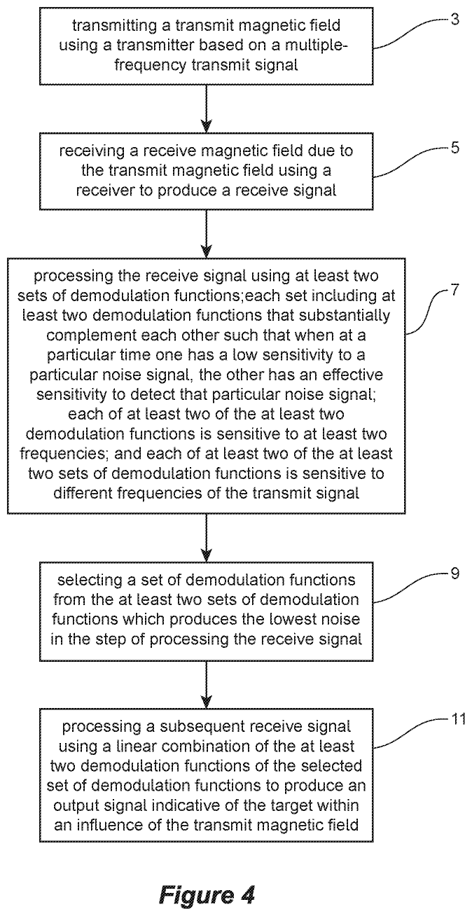

In a general form of one embodiment with reference to FIG. 4, the following steps are performed. Firstly, the step 3 of transmitting transmit magnetic field using a transmitter based on a multiple-frequency transmit signal is performed. In one form the transmitter is a magnetic coil, and may take a form of a mono-loop coil, double D coil (DD coil), concentric (CC coil), DOD coil, and other forms known to be used in the field of metal detection. The transmit magnetic field is generated by sending a transmit signal, sometimes known as transmit waveform, to the transmitter. A multiple-frequency transmit signal is understood to mean a signal including two or more main frequency components, as contrast with a single-frequency detector.

The next step 5 is the step of receiving a receive magnetic field due to the transmit magnetic field using a receiver to produce a receive signal. The receiver may be the same winding as the transmitter (in the case of a mono-loop), or it can be one of the windings in a DD coil, DOD coil etc.

The next step 7 is the step of processing the receive signal using at least two sets of demodulation functions; each set including at least two demodulation functions that substantially complement each other such that when at a particular time one has a low sensitivity to a particular noise signal, the other has an effective sensitivity to detect that particular noise signal; each of the at least two demodulation functions is sensitive to at least two frequencies; and each of the at least two sets of demodulation functions is sensitive to different frequencies of the transmit signal.

In the context of this specification, unless stated otherwise, the term “complement” is to be understood based on the following: The at least two demodulation functions that substantially complement each other are performing “complex demodulation”. From the two demodulation functions the complex demodulated signal is produced. That is, both the real and imaginary components are produced. The two demodulation functions complement each other such that the functions demodulate both the real and imaginary components of a receive signal. In this sense, the demodulation functions complement each other such that in the frequency-domain, for all relevant frequencies, one demodulation function is either π/2 radians or −π/2 radians out of phase with the other demodulation function, and for all relevant frequencies, both demodulation functions have approximately the same gain. The crucial consequence of this is that narrow-band noise occurring on a single frequency only will appear as sinusoidal oscillations when demodulated with the two complementary demodulators, and these sinusoidal oscillations will have a phase-difference of π/2 radians and an approximately constant relative gain, irrespective of the frequency of the narrow-band noise, for all relevant frequencies. This allows a multi-frequency metal detector that receives on multiple frequencies simultaneously to sense the presence and estimate the magnitude of narrow-band noise by instantaneous sampling of the two complementary demodulated signals. This reduces the time required to detect the presence and estimate the magnitude of narrow-band noise.

It can be more practical, especially where the demodulation functions are to be implemented in analogue hardware, to implement demodulation functions which are not themselves “complementary” in a way previously described. In an alternative embodiment, the demodulated signals are subsequently processed to approximate the demodulated signals which would have been produced by complementary demodulation functions. In this case, the processed demodulated signals are effectively produced from complementary demodulation functions. As such, in the context of this specification, we extend the term “complement” to include this case. Practically speaking, for example, this alternative embodiment may be achieved wherein the two implemented demodulation functions are approximately in the space spanned by two complementary demodulation functions, such that the two complementary demodulation functions could be constructed approximately as linear combinations of the two implemented demodulation functions.

In the context of this specification, unless stated otherwise, the term “substantially” is to be understood based on the following: The at least two demodulation functions that substantially complement each other need not completely (100%) complement each other, rather the degree of substantially complement very much depends on the application. In practice, the more they complement each other, the more accurately the instantaneous noise level can be estimated. In one exemplary form, the at least two demodulation functions that substantially complement each other are approximately π/2 radians (within 5%) out of phase with respect to each other for all frequencies below about 100 kHz. In another exemplary form, the at least two demodulation functions that substantially complement each other are approximately π/2 radians (within 3%) out of phase with respect to each other for all frequencies below about 15 kHz. In one form, the frequency range is up to 15 kHz to cover most EMI signals. When the potential interfering noise sources are expected at frequencies higher than 15 kHz, for example, where the noise source is a VLF transmitter, the frequency range is to be extended to include the relevant noise sources.

One method for generating a second demodulation function which complements a first demodulation function is to construct the second demodulation as being the Hilbert transform of the first demodulation function. In the case of discrete demodulation functions, a second demodulation function Y can be created from a first demodulation function X as

Y=DHT{X}

where DHT{X} is the discrete Hilbert transform of X.

Generally, a second demodulation function which complements a first demodulation function can be constructed by applying the Fourier transform of the first demodulation function, adding a phase shift (e.g. π/2 radians) to each component in the Fourier domain, then applying the inverse Fourier transform to produce the second demodulation function. In the case of discrete demodulation functions, a second demodulation function Y can be created from a first demodulation function X as

Y=F⁻¹(G(F(X))

where the function F is the discrete Fourier transform, the function F⁻¹ is the inverse discrete Fourier transform, and the function G is the phase-shift operation in the Fourier domain

Using at least two demodulation functions that substantially complement each other rather than using only one increases accuracy in determining noise and/or reduces the time required for determining the noise. This is because while a single function may be sensitive to a particular noise signal, when sampled at a single moment in time, the noise signal may still be erroneously determined to be close to zero. This can occur when fluctuations in the noise are instantaneously small, for instance when an oscillatory noise signal is near a zero-crossing in amplitude. With two substantially complementing demodulator functions, the complementing demodulator is such that, for all noise oscillation frequencies, when the output of the first demodulator is passing close to zero, the output of the complementing demodulator is close to a maximum. That is, the outputs of the first and second demodulators are out-of-phase by approximately π/2 radians. If one samples both demodulators at any instant of time, one of them can be used to detect the presence of a noise oscillation. In one embodiment, the magnitude (square-root of the sum of the squares) of the two demodulator outputs is used to detect the noise.

The features of “each of the at least two demodulation functions is sensitive to at least two frequencies” and “each of the at least two sets of demodulation functions is sensitive to different frequencies of the transmit signal” are further elaborated below. The features require that there are two sets of at least two demodulation functions, sensitive to different frequencies of the transmit signal. The term “different” does not exclude the possibility of overlapping. For example, the first set may be sensitive to 10 kHz and 30 kHz, while the second set may be sensitive to 10.1 kHz and 30.3 kHz and the third set (if exists) 6 kHz and 30 kHz. The term “different” simply means that when considering all the frequencies that a set is sensitive to, they are not all the same. Within each set, each of the at least two demodulation functions are both sensitive to at least two frequencies. What it means is that it is not a simple sine or cosine demodulation. The present disclosure uses a function that is sensitive to multiple frequencies, then prepares a complementary version of that function. Both functions (the original and the complementary version) are then considered a set. There are at least two sets for selection; each set corresponds to different frequencies as described above. This allows quick determination of noise, and selection of the most suitable demodulation function for a multi-frequency metal detector at a certain location.

Referring to step 7, one of the at least two demodulation functions is configured and adapted to detect the target in one embodiment. Alternatively, a combination of at least two of the at least two demodulation functions is configured and adapted to detect the target.

The next step 9 is the step of selecting a set of demodulation functions from the at least two sets of demodulation functions which produces the lowest noise in the step of processing the receive signal.

The next step 11 is the step of processing a subsequent receive signal using a linear combination of the at least two demodulation functions of the selected set of demodulation functions to produce an output signal indicative of the target within an influence of the transmit magnetic field. Note that the linear combination, in the context of this specification, includes cases where only one of the two demodulation functions is used (i.e. linear combination of x and y can be presented as a×x+b×y, and a linear combination, when a or b is zero, means effectively either x or y is used only).

By performing the above steps, one is able to quickly, in terms of duration of the process, and computationally efficiently detect the presence and approximate relative magnitude of interfering signals (e.g. EMI) in order to select a demodulation function which has low (or lowest) sensitivity to these interfering signals. This provides convenience in the form of a shorter wait time to complete the search of available demodulation functions, and simplicity in that the search could be performed at a time where the metal detector would otherwise not be operated normally, for example immediately after the detector is powered on, without unduly lengthening these times, such that the user interface would not require the ability from the operator to trigger a demodulation function search process.

In one form, the demodulation functions are analogue demodulation functions, with gains applied to signals in time windows, for example as described in U.S. Pat. No. 8,106,770. There would be a corresponding complementary “quadrature” demodulation function for each of these demodulation functions. These quadrature demodulation functions are complementary to the original analogue demodulation functions in that they are approximately π/2 radians or −π/2 radians out of phase with the original analogue demodulation functions for all relevant frequencies, and the ratio of the gains of the quadrature demodulation functions and the original analogue demodulation functions is approximately constant for all relevant frequencies. The transmitter is turned off during processing of the receive signal using the “quadrature” demodulation function to prevent overloading the receiver. With the transmitter turned off, another advantage is that the transmitter will no longer induce eddy currents in nearby conductive objects nor will it magnetise the soil, both of which can generate receive signals that can interfere with the measurement of EMI noise.

In one form, the metal detector is a time-domain detector, and the at least two sets of demodulation functions are sets of time-domain demodulation functions. In another form, the metal detector is a frequency-domain detector.

In one form, the transmit magnetic field is turned off temporarily during the step of processing the receive signal using at least two sets of demodulation functions. Note that this step is not necessary, but can offer certain benefits in certain configurations as discussed previously in relation to “quadrature” demodulation function. In one form, the at least two demodulation functions that substantially complement each other are approximately π/2 radians or −π/2 radians out of phase for all relevant frequencies, and have an approximately constant ratio of gains for all relevant frequencies.

In one form, a signal of multiple frequencies is fed to the transmitter to generate the transmit magnetic field. A multiple frequency signal can offer extra depth and/or additional discrimination ability when compared with a single frequency detector. In one form, the step of processing the receive signal using at least two sets of demodulation functions is performed when the detector is powered up or when a user of the metal detector instructs the metal detector to do so, for example by pressing a button, or performing a gesture such as moving the detector in a specific manner In one form, there are at least ten sets of demodulation functions; and wherein the step of processing the receive signal using at least two sets of demodulation functions for selecting the set of demodulation functions which produces the lowest noise is completed within 10 second. In another form, there are more than ten sets of demodulation functions, each set includes between two to twenty functions, with at least two functions that substantially complement each other such that when one has a low sensitivity to a particular noise signal at least one of the other functions does not have low sensitivity to that particular noise signal. In one form, there is more than one pair of functions that substantially complement each other.

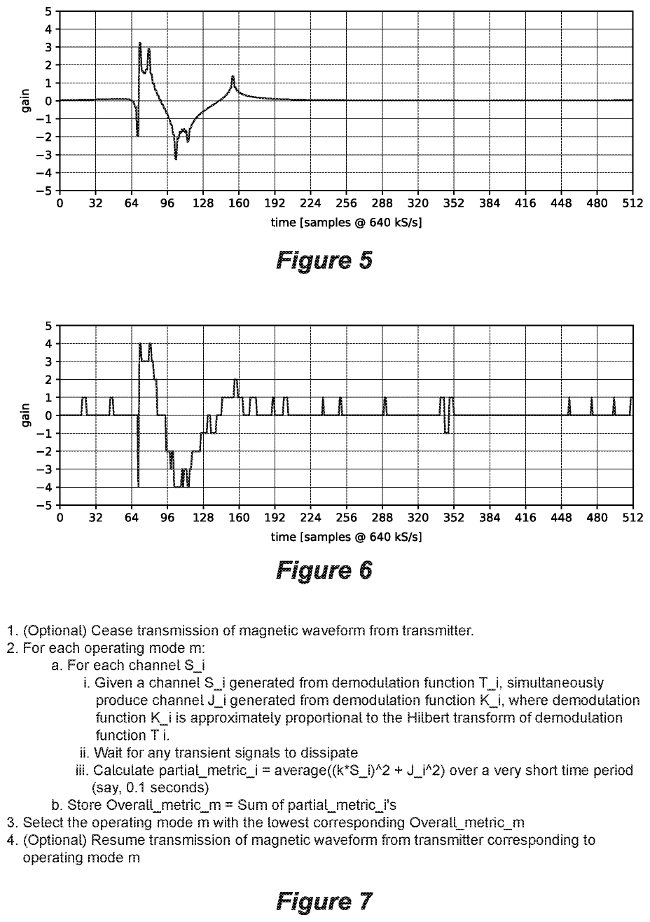

Turning back to the demodulation function of FIG. 3, a corresponding complementary demodulation function is the discrete Hilbert transform of the demodulation function. This complementary demodulation function is shown in FIG. 5.

The following presents a working example. There are at least two sets of functions. There may be more than tens or even hundreds of sets. Depending on the advancement in processing power, there is no upper limit of how many sets can be stored and processed by a metal detector. In practice at the time of drafting this specification, it is envisaged that there would be from five to one thousand sets of functions.

For each unique first demodulation function sensitive to multiple frequencies a second demodulation function is generated. The second demodulation function is such that it is sensitive to substantially the same frequencies as the first demodulation function and for each of these frequencies the phase response of the second demodulation function is offset by approximately π/2 radians from the phase response of the first demodulation function. Additionally, the second function has an approximately constant gain relative to the first function for all relevant frequencies.

Both the first and second demodulation functions may act on the receive signal directly. Alternatively either or both demodulation functions may be constructed as linear combinations of other demodulation functions which act on the receive signal.

In order to estimate the amplitude of the EMI present in the first demodulation, the measured response in both the first and second demodulated channels are used.

If the magnitude response of the second demodulation function is the same as the magnitude response of the first demodulation function, and if the phase response of the second demodulation function and the phase response of the first demodulation function are expected to differ by π/2 radians, then ideally the first channel S and the second channel J should be combined as

Metric_1=f(S²+J²)

where f is some function, which may be the identity function. However, it is also effective to combine the two channels in other ways which preserve an indication of the size of both J and S, for instance

Metric_2=f(|S|+|J|)

where |S| and |J| are the absolute values of S and J respectively.

If the expected approximate ratio of the magnitude responses of J and S is k, then the channels may be rescaled in calculating the metric, for instance

Metric_3=f(S²+(k×J)²)

If the phase response of the first demodulation function and the phase response of the second demodulation function do not differ by π/2 radians, the two channels can be approximately orthogonalised. This approximate orthogonalisation can be performed in the construction of the metric as

Metric_4=f(S²+(k×J−g×S)²)

where g is a scalar chosen such that g×S is approximately the projection of k×J onto S, and k is approximately the ratio of the magnitude responses of J and S.

Given the first demodulation function, one method to generate the second demodulation function is to take the Hilbert transform of the first demodulation function. For a first demodulation function defined as a discrete function of time, the second demodulation function can be generated by taking the discrete Hilbert transform of the first demodulation function. The discrete Hilbert transform of the first demodulation function shown in FIG. 3 is shown in FIG. 5. The magnitude response is identical to that of the first demodulation function, and the phase response is offset by exactly π/2 radians. Note, however, that the first demodulation function is more readily implementable on a platform with few available gain values for the demodulation function, such is the case with many pulse induction metal detectors, where the gain values for the demodulation function are defined by DC-gain values of amplifier circuits. The second demodulation function is, by contrast, not readily implementable on such a platform. Some modifications may be required to generate an approximation of the second demodulation function which is implementable on a platform with few available gain values, while approximately maintaining the properties of equivalent magnitude response and π/2 radian phase offset relative to the first demodulation function. Such modifications may include rounding the gain values of the second demodulation function to the nearest available gain level, or pulse-code modulating the second demodulation function to utilise only the available gain levels. An example of a modified second demodulation function quantised to nine gain levels is shown in FIG. 6. This example of a modified second demodulation function approximates the demodulation function shown in FIG. 5, and has a similar Fourier transform up to 20 kHz. On a digital platform, where the demodulation operation is performed in digital signal processing, modification of the second demodulation function may be unnecessary.

An example of how an automatic selection of an approximately optimal operating mode may be performed, for a two-channel pulse induction metal detector, is shown as FIG. 7.

Typically, in step 2.a.ii. the transient signals dissipate in much less time than the 0.1 seconds over which the measurement in step 2.a.iii. occurs. If the transient signals dissipate over a negligible period of time, and if for each operating mode m there are two channels S_1 and S_2 which are measured serially, then each operating mode can be iterated over in approximately 0.2 seconds in the above scheme, and 10 operating modes can be iterated over in approximately 2 seconds with substantially reduced risk of non-detection of low-frequency EMI oscillations relative to the existing automatic EMI rejection schemes for pulse induction or multi-frequency metal detectors. At this time duration (2 seconds), it becomes viable to perform such a process during the power-on process of a metal detector, without burdening the user with a lengthy wait time. One potential advantage of this is that it enables the removal of a user-activated function, thus reducing the complexity of the user interface of a metal detector. Note: the optional step of ceasing the transmission of magnetic waveform from transmitter while performing the above process is beneficial for a few reasons:
a) Prevents overloading the receive circuit when demodulating during periods where the transmit voltage is applied to the transmit coil which may couple into the receive coil; and
b) Prevents generating spurious signals due to detection of metallic objects while measuring the noise floor produced in each operating mode.

Those of skill in the art would understand that information and signals may be represented using any of a variety of technologies and techniques. For example, data, instructions, commands, information, signals, bits, symbols, and chips may be referenced throughout the above description and may be represented by voltages, currents, electromagnetic waves, magnetic fields or particles, optical fields or particles, or any combination thereof.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. For a hardware implementation, processing may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. Software modules, also known as computer programs, computer codes, or instructions, may contain a number of source code or object code segments or instructions, and may reside in any computer readable medium such as a RAM memory, flash memory, ROM memory, EPROM memory, registers, hard disk, a removable disk, a CD-ROM, a DVD-ROM or any other form of computer readable medium. In the alternative, the computer readable medium may be integral to the processor. The processor and the computer readable medium may reside in an ASIC or related device. The software codes may be stored in a memory unit and executed by a processor. The memory unit may be implemented within the processor or external to the processor, in which case it can be communicatively coupled to the processor via various means as is known in the art.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement or any form of suggestion that such prior art forms part of the common general knowledge.

It will be appreciated by those skilled in the art that the invention is not restricted in its use to the particular application described. Neither is the present disclosure restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

1. A method for detecting a target using a metal detector, including:
transmitting a transmit magnetic field using a transmitter based on a multiple-frequency transmit signal;
receiving a receive magnetic field due to the transmit magnetic field using a receiver to produce a receive signal;
processing the receive signal using at least two sets of demodulation functions; each set including at least two demodulation functions that substantially complement each other such that when at a particular time one has a low sensitivity to a particular noise signal, the other has an effective sensitivity to detect that particular noise signal; each of at least two of the at least two demodulation functions is sensitive to at least two frequencies; and each of at least two of the at least two sets of demodulation functions is sensitive to different frequencies of the transmit signal;
selecting a set of demodulation functions from the at least two sets of demodulation functions which produces the lowest noise in the step of processing the receive signal; and
processing a subsequent receive signal using a linear combination of the at least two demodulation functions of the selected set of demodulation functions to produce an output signal indicative of the target within an influence of the transmit magnetic field.

2. The method of claim 1, wherein the metal detector is a time-domain detector, and the at least two sets of demodulation functions are sets of time-domain demodulation function.

3. The method of claim 1, wherein the transmit magnetic field is turned off temporarily during the step of processing the receive signal using at least two sets of demodulation functions.

4. The method of claim 1, wherein the at least two demodulation functions that substantially complement each other are substantially related by a Hilbert transform.

5. The method of claim 1, wherein the at least two demodulation functions that substantially complement each other substantially have either π/2 radians or −π/2 radians phase difference for all relevant frequencies in the frequency domain.

6. The method of claim 1, wherein a signal of multiple frequencies is fed to the transmitter to generate the transmit magnetic field.

7. The method of claim 1, wherein the step of processing the receive signal using at least two sets of demodulation functions is performed when the detector is powered up or when a user of the metal detector instructs the metal detector to do so.

8. The method of claim 1, wherein there are at least ten sets of demodulation functions; and wherein the step of processing the receive signal using at least two sets of demodulation functions for selecting the set of demodulation functions which produces the lowest noise is completed within 1 second.

9. The method of claim 1, wherein at least one of the at least two demodulation functions is configured and adapted to detect the target.

10. The method of claim 1, wherein a combination of at least two of the at least two demodulation functions is configured and adapted to detect the target.

11. A method for detecting a target using a metal detector, including:
transmitting a transmit magnetic field using a transmitter based on a multiple-frequency transmit signal;
receiving a receive magnetic field due to the transmit magnetic field using a receiver to produce a receive signal;
processing the receive signal using at least two sets of demodulation functions; each of at least two of the at least two sets of demodulation functions is sensitive to different frequencies of the transmit signal; each set including at least two demodulation functions, the at least two demodulation functions are in a space spanned by at least two complementary demodulation functions, wherein the at least two complementary demodulation functions substantially complement each other such that when at a particular time one has a low sensitivity to a particular noise signal, the other has an effective sensitivity to detect that particular noise signal; each of at least two of the at least two complementary demodulation functions is sensitive to at least two frequencies;
selecting a set of demodulation functions from the at least two sets of demodulation functions which produces the lowest noise in the step of processing the receive signal; and
processing a subsequent receive signal using a linear combination of the at least two demodulation functions of the selected set of demodulation functions to produce an output signal indicative of the target within an influence of the transmit magnetic field.

12. A metal detector including:
a transmitter for transmitting a transmit magnetic field based on a multiple-frequency transmit signal;
a receiver for receiving a receive magnetic field due to the transmit magnetic field to produce a receive signal;
a processor for:
processing the receive signal using at least two sets of demodulation functions; each set including at least two demodulation functions that substantially complement each other such that when at a particular time one has a low sensitivity to a particular noise signal, the other has an effective sensitivity to detect that particular noise signal; each of the at least two demodulation functions is sensitive to at least two frequencies; and the at least two sets of demodulation functions is sensitive to different frequencies of the transmit signal;
selecting a set of demodulation functions from the at least two sets of demodulation functions which produces the lowest noise in the step of processing the receive signal; and
processing a subsequent receive signal using a linear combination of the at least two demodulation functions of the selected set of demodulation functions to produce an output signal indicative of the target within an influence of the transmit magnetic field.

13. A non-transitory computer readable medium including instructions to perform the steps of claim 1.

14. A non-transitory computer readable medium including instructions to perform the steps of claim 11.
